(19) United States
(12) Patent Application Publication
(10) Pub. No.: US 2010/0326759 A1
(43) Pub. Date: Dec. 30, 2010

(54) HAND CONTROL APPARATUS IN A VEHICLE

(76) Inventor: Zhide Feng, Troy, MI (US)

Correspondence Address: PATWRITE LLC, 408 W. MAIN ST., MARSHALLTOWN, IA, 50158-5759, US

(21) Appl. No.: 12/828,276

(22) Filed: Jun. 30, 2010

Related U.S. Application Data
(63) Continuation-in-part of application No. 11/756,633, filed on Jun. 1, 2007, now abandoned.
(60) Provisional application No. 60/816,009, filed on Jun. 22, 2006.

(51) Int. Cl. B60K 26/02

(52) U.S. Cl. 180/333

(57) ABSTRACT

A hand control apparatus in a vehicle allows a disabled driver to operate the vehicle without using their feet. The push-pull style handle control apparatus is attached either to the steering column mount or instrument panel. An operation lever is cross-car (left-to-right) oriented and pivotally mounted at its mid-section through a pivot bracket to the steering column or instrument panel. A brake lever and an accelerator at both of near ends are pivoted to the bracket and both operate using the operation lever; with one oriented to the left and the other to the right. In this way, when the free end of the operation lever is pressed down, it pushes down the far end of the brake lever and an OEM brake arm through a brake rod. Similarly, when the free end operation lever is lifted up, it pushes down an OEM accelerator arm through an accelerator rod.

### CROSS REFERENCE TO RELATED APPLICATIONS

This is a continuation in part of U.S. patent application Ser. No. 11/756,633, filed Jun. 6, 2007, which in turn claims priority to Provisional Application Ser. No. 60/816,009, filed on Jun. 22, 2006, the complete disclosures of each of which are hereby incorporated by reference.

### BACKGROUND OF THE INVENTION

The automobile has become a symbol of independence as well as enabling a suburban way of life that is unique to modern life. Unfortunately, not everyone is readily able to take advantage of this revolution since most vehicles are designed to be operated by non-disabled drivers. Most vehicles require the operator to use their feet to control the vehicle. There is a need for a simple interfacing mechanism that allows a user to operate a vehicle without using their feet.

### SUMMARY OF THE INVENTION

A hand control apparatus in a vehicle allows a disabled driver to operate the vehicle without using their feet. The push-pull style handle control apparatus is attached either to the steering column mount or instrument panel. An operation lever is cross-car (left-to-right) oriented and pivotally mounted at its mid-section through a pivot bracket to the steering column or instrument panel. A brake lever and an accelerator at both of near ends are pivoted to the bracket and both operate using the operation lever; with one oriented to the left and the other to the right. In this way, when the free end of the operation lever is pressed down, it pushes down the far end of the brake lever and an OEM brake arm through a brake rod. Similarly, when the free end operation lever is lifted up, it pushes down an OEM accelerator arm through an accelerator rod.

Other features and advantages of the instant invention will become apparent from the following description of the invention which refers to the accompanying drawings.

### BRIEF DESCRIPTION OF THE DRAWINGS

FIG. 1 is a perspective view of an embodiment according to the present invention.

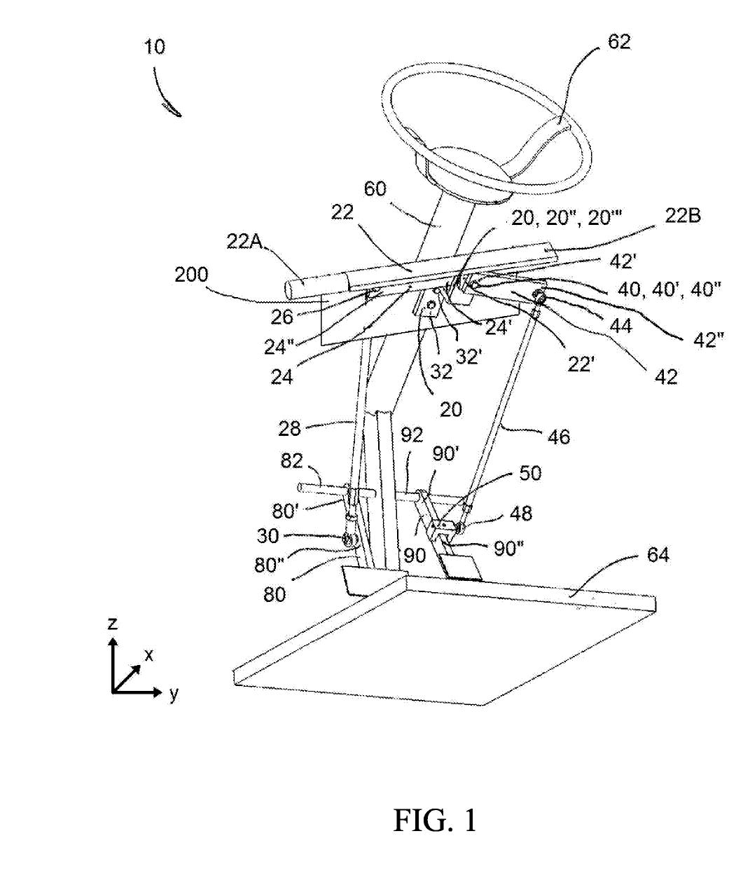

FIG. 2 is another perspective view of an embodiment according to the present invention.

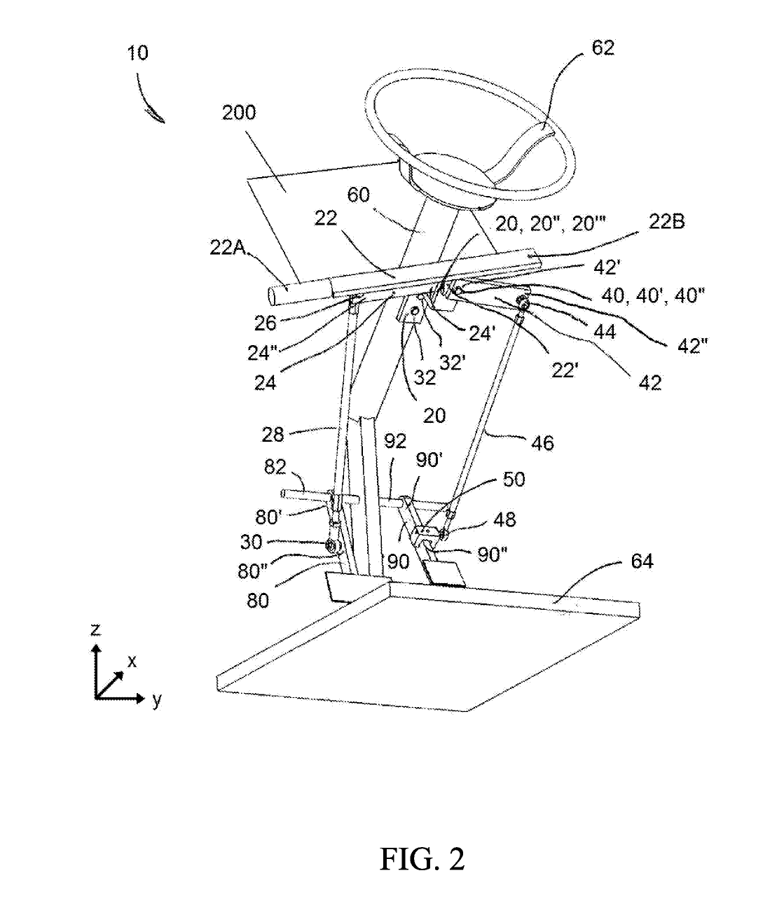

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

As shown in the figures, a conventional (one not specially made for disabled drivers) vehicle usually has floor panel 64, a brake pedal 80 mounted on floor panel 64 through brake pedal first pivot 82, and has an accelerator pedal 90 mounted on floor panel 64 through accelerator pedal first pivot 92. The vehicle usually also has a steering column 60, a steering wheel 62 and instrument panel 200.

When a conventional driver presses down brake pedal 80 by his/her foot, the vehicle will be slowed down up to full stop. When the conventional driver presses down accelerator pedal 90 by his/her foot, the vehicle will speed up.

A pivot bracket 20 is fixed to steering column 60 or instrument panel 200 using pivot bracket fastener 32 and 32′. A first pivot location 20′ of pivot bracket 20 is installed with operation lever 22 by fastener 40 in its mid-section 22′, which is provides the operator with a mechanical advantage by having the left and right ends at a significant distance from the pivot point.

Operation lever 22 is usually basically oriented in cross-car direction. The brake lever 24 is basically oriented in cross-car direction as well. Its near-end 24′ is connected to a second pivot location 20″ of pivot bracket 20 by fastener 40′, which is usually co-instant with first pivot location 20′. Brake lever 24 is basically arranged under operation lever 22, therefore, when operation lever 22 is pressed down at its brake end 22A, brake lever 24 is indirectly pressed down too. But when said brake end 22A is lifted up, brake lever 24 does not have to follow the movement of operation lever 22 (not necessary moving up).

The top end of a brake rod 28 is attached to a far-end 24″ of brake lever 24 through joint (usually universal joint) 26. Usually one end 80′ of the OEM brake pedal 80 is attached to floor panel 64 (or through some bracket) by brake pedal first pivot 82. A second location 80″ (which is different from said end 80′) is connected with the lower end of brake rod 28 through joint (usually universal joint) 30.

Therefore, when brake end 22A of operation lever 22 is pressed down, it will drive down brake lever 24, brake rod 28, and press down brake pedal 80, and the vehicle will be braked.

An accelerator lever 42 is also basically oriented in cross-car direction too but in opposite direction of brake lever 24. Its near-end 42′ is connected to a third pivot location 20′″ of pivot bracket 20 by fastener 40″, which is usually co-instant with first pivot location 20′. Accelerator lever 42 is basically arranged under operation lever 22, therefore, when accelerator end 22B is pressed down (operated by lifting brake end 22A), accelerator lever 42 is indirectly pressed down at its far-end 42″ as well. But when accelerator end 22B is lifted up (operated by pressing down brake end 22A), accelerator lever 42 does not have to follow the movement of accelerator end 22B (not necessary moving up).

The top end of an accelerator rod 46 is attached to the far-end 42″ of accelerator lever 42 through joint (usually universal joint) 44. Usually one end 90′ of the OEM accelerator pedal 90 is attached to floor panel 64 (or through some bracket) by accelerator pedal first pivot 92. A second location 90″ (which is different from the end 90′) is connected with the lower end of accelerator rod 46 through joint (usually universal joint) 48 and sometimes through bracket 50.

Therefore, when accelerator end 22B is pressed down by lifting brake end 22A of operation lever 22, it will drive down accelerator lever 42, accelerator rod 46, and press down accelerator pedal 90, and the vehicle will be accelerated.

At this moment the operation lever 22 is departed from joint 26. In the case pressing down brake end 22A, accelerator lever 42 is departing from operation lever 22. Therefore when the beginning location among operation lever 22, brake lever 24 and accelerator lever 42 are carefully adjusted, operation of accelerating and operation of braking will be contradicted with each other. In other words, when brake pedal 80 is pressed down, the accelerator pedal 90 is automatically released (no acceleration action); when accelerator pedal 90 is pressed down, the brake pedal is automatically released (no braking action).

This kind of system of operating a vehicle is called a push-pull style hand control means, where the operation of acceleration and braking are opposite each other. Theoretically there is no way to make the mistake of actuating both brake and accelerator at the same time.

Although the instant invention has been described in relation to particular embodiments thereof, many other variations and modifications and other uses will become apparent to those skilled in the art.

What is claimed is:

1. A hand control for operating a conventional vehicle using hands, said vehicle having a floor panel, a brake pedal mounted on floor panel through a brake pedal first pivot, said brake pedal also having a second location which is lower and more rearward than the location of said first pivot;
said vehicle also having an accelerator pedal mounted on said floor panel through an accelerator pedal first pivot; said accelerator pedal also having a second location which is lower and more rearward than the location of said first pivot;
said vehicle also having a steering column and instrument panel adjacently disposed to said steering wheel, said hand control comprising:
an operation lever, said operation lever being generally oriented in cross-car direction, and having an brake end and accelerator end, and a mid-section which is located between said brake end and said accelerator end;
an operation lever fastener pivotally mounting said mid-section of said operation lever to a selected attachment location;
a brake lever having a near-end and a far-end, said brake lever having generally the same orientation as said operation lever and being adjacent to said operation lever;
a brake lever near-end fastener attaching said brake lever pivotally to said selected attachment location;
a brake rod having top end and lower end;
a brake lever far-end fastener attaching said brake rod at its top end to said far-end of said brake lever;
a brake pedal second fastener attaching said lower end of said brake rod to said second location of said brake pedal;
an accelerator lever having a near-end and a far-end, said accelerator lever having a generally opposite orientation as said brake lever and being adjacent to said operation lever;
an accelerator lever near-end fastener attaching said accelerator lever at its near end pivotally to said selected attachment location;
an accelerator rod having top end and lower end;
an accelerator lever far-end fastener attaching said accelerator rod at its top end to said far-end of said brake lever;
an accelerator pedal second fastener attaching said lower end of said accelerator rod to said second location of said accelerator pedal; and
whereby when said operation lever is rotated around said operation lever fastener in one direction, it will create braking action without accelerating action to said vehicle; while said operation lever is turned in opposite direction, it will create accelerating action without braking action to said vehicle.

2. A hand control for operating a conventional vehicle using hands according to claim 1 further comprising a pivot bracket; said pivot bracket being connected to said selected attachment location, said mid-section of said operation lever, said near end of said brake lever and said near end of said accelerator lever being connected to said pivot bracket first and then to said selected attachment location through said pivot bracket.

3. A hand control for use in a conventional vehicle, said vehicle having a floor panel, a brake pedal mounted on floor panel through a brake pedal first pivot, said brake pedal also having a second location which is lower and more rearward than the location of said first pivot;
said vehicle also having an accelerator pedal mounted on said floor panel through an accelerator pedal first pivot; said accelerator pedal also having a second location which is lower and more rearward than the location of said first pivot;
the vehicle also having a steering column and instrument panel adjacently disposed to said steering wheel, said hand control comprising:
an operation lever, said operation lever being generally oriented in cross-car direction, and having an brake end and accelerator end, and a mid-section which is located between said brake end and said accelerator end;
an operation lever fastener pivotally mounting said mid-section of said operation lever to a selected attachment location;
a brake lever having a near-end and a far-end, said brake lever having generally the same orientation as said operation lever and being adjacent to said operation lever;
a brake lever near-end fastener attaching said brake lever pivotally to said selected attachment location;
a brake rod having top end and lower end;
a brake lever far-end fastener attaching universally said brake rod at its top end to said far-end of said brake lever;
a brake pedal second fastener attaching said lower end of said brake rod universally to said second location of said brake pedal;
an accelerator lever having a near-end and a far-end, said accelerator lever having generally opposite orientation as said brake lever and being adjacent to said operation lever;
an accelerator lever near-end fastener attaching said accelerator lever at its near end pivotally to said selected attachment location;
an accelerator rod having top end and lower end;
an accelerator lever far-end fastener attaching universally said accelerator rod at its top end to said far-end of said brake lever;
an accelerator pedal second fastener attaching said lower end of said accelerator rod universally to said second location of said accelerator pedal;
whereby when said operation lever is rotated around said operation lever fastener in one direction, it will create braking action without accelerating action to said vehicle; while said operation lever is turned in opposite direction, it will create accelerating action without braking action to said vehicle.

4. A hand control for operating a conventional vehicle using hands according to claim 1 wherein said selected attachment location is located on said steering column.

5. A hand control for operating a conventional vehicle using hands according to claim 1 wherein said selected attachment location is located on said instrument panel.
